(19) United States
(12) Patent Application Publication
(10) Pub. No.: US 2011/0085255 A1
(43) Pub. Date: Apr. 14, 2011

(54) DEVICE FOR ADJUSTING SIDE MIRRORS OF AN AUTOMOBILE

(76) Inventor: Hee Kwan KOO, Seoul (KR)

(21) Appl. No.: 12/899,631

(22) Filed: Oct. 7, 2010

(30) Foreign Application Priority Data
Oct. 9, 2009 (KR) 2009-0096202

(51) Int. Cl. B60R 1/08; B60R 1/072

(52) U.S. Cl. 359/843

(57) ABSTRACT

The present invention provides a device for adjusting side mirrors of an automobile, in which a film mirror of a side mirror is manipulated to be convex simultaneously with the blinking of a turn signal lamp when a driver turns directions during road traveling. This allows the driver to conveniently recognize the situations of the road behind, thereby preventing accidents caused by a blind spot.

### CROSS-REFERENCE TO RELATED APPLICATIONS

Not Applicable

### STATEMENT REGARDING FEDERALLY SPONSORED RESEARCH

Not Applicable

### PARTIES TO JOINT RESEARCH AGREEMENT

Not Applicable

### REFERENCE TO APPENDIX

Not Applicable

### FIELD OF THE INVENTION

The present invention relates to a device for adjusting side mirrors of an automobile, in which a film mirror of a side mirror of a car is manipulated to be convex simultaneously with the blinking of a turn signal lamp when a driver turns directions while driving the car on a road, so as to allow the driver to conveniently recognize the situations of the road behind, thereby preventing accidents caused by a blind spot.

### BACKGROUND OF THE INVENTION

In general, vehicles traveling on roads are provided with side mirrors for allowing drivers to see a portion of the road behind or beside the vehicle and the drivers operate turn signal lamps in the direction they intend to turn by manipulating turn signal levers in the case of direction or lane changes.

A driver typically uses a side mirror 10 mounted in a vehicle 1 as shown in FIG. 1 by manipulating a switch or the like in the vehicle to control the side mirror 10 at an optimum angle to recognize side or rear situations. In other words, the side mirror 10 includes a glass mirror mounted in a housing and having a planar reflection surface, wherein the glass mirror is controllable vertically and horizontally in angle by means of a motor mounted in the housing. Therefore, the side minors 10 at both sides of the vehicle 1 are manipulated according to the view of the driver so as to allow the driver to see the road behind or beside the vehicle while traveling the road, thereby increasing the safety of the road traveling.

The side mirror as mentioned above, however, is formed as a plane or planar mirror and respectively mounted to the doors adjacent a driver's seat and a passenger's seat in a relatively small size, so that it is very difficult for a driver to clearly recognize a road behind at the driver's seat. In other words, the side mirror is limited in size and the driver has to recognize the road behind at the driver's seat, so that the backward view of the driver through the side minor is extremely narrow and limited.

Therefore, blind spots where the driver cannot see via the side mirrors are generated in the case of lane changes or direction changes during road traveling, so that the driver may obstruct the driveway of other vehicles running beside his vehicle against his will, thereby causing a traffic accident such as a fender bender or a rear-end collision in a serious case.

Further, when the driver backs his vehicle, he has to check the side minors at both sides simultaneously. However, viewing angles of the side mirrors, which are controlled according to a traveling state, are not appropriate for the driver to precisely recognize a road condition and the advancing state of his vehicle, so that the driver has to manipulate the side mirrors downwards or check the road condition and the vehicle advancing state with the naked eyes by sticking his head out inconveniently.

In order resolve the above problems, according to one approach, a supplementary mirror formed of a convex minor in general is mounted to the side minor. Such a supplementary minor, however, spoils the appearance of the vehicle and the rear view provided through such a small-sized supplementary mirror is not enough to clearly determine a distance or a width for precise recognition thereof.

### SUMMARY OF THE INVENTION

The present invention has been made with a view to solving the above-identified problems, and an object thereof is to provide a device for adjusting side mirrors of an automobile, in which a film mirror of a side mirror of a vehicle is manipulated to be convex simultaneously with the operation of a turn signal lever for the precise recognition of a blind spot in the case of a direction change or a lane change during the road traveling of the vehicle.

Another object of the present invention is to provide a device for adjusting side minors, in which a rear surface of the film mirror is pushed by a moving means that is controlled by a general turn signal lever mounted beside a steering wheel, so that the entire shape of the film minor becomes a convex minor to secure a wide rear view.

A still another object of the present invention is to provide a device for adjusting side minors, in which an electric motor, a solenoid or an actuator may be employed as for the moving means positioned at the rear surface of the film mirror in a body part of a housing and controlled by the turn signal lever.

A further object of the present invention is to provide a device for adjusting side minors, in which as a gear shift is manipulated for backing a vehicle, moving means of the side mirrors at the right and left sides of the vehicle are simultaneously driven to push the film minors of the side minors at the right and left sides for converting the film minors into a concave spherical shape.

To achieve the above objects, in a device for adjusting side mirrors of an automobile 1 mounted with side minors 10 on right and left sides of a vehicle body, a moving means 20 is mounted in a housing 11 of the side mirror 10 to be controlled by the manipulation of a turn signal lever 2 and a film mirror 30 is fitted in a holding groove 12 of the housing 11 in front of the moving means 20. The moving means 20 is driven according to a signal in response to the manipulation of the turn signal lever 2 in the state that a pressing plate 21 integrally assembled in front of the moving means 20 is in contact with a rear surface of the film mirror 30, so that the film mirror 30 becomes convex while the pressing plate 21 moves forwards. Further, the moving means 20 is formed of an electric motor, a solenoid or an actuator. Furthermore, the moving means 20 of the both side mirrors 10 at the right and left sides are driven simultaneously for making the film mirrors 30 of the both side minors 10 convex if a gear shift 3 of the vehicle 1 is manipulated to a reverse shift stage.

According to the present invention as constructed above, the side mirror is used as a plane or planar mirror with a plane reflection surface in case of normal road traveling, and used as a convex mirror with a convex film mirror in case of a direction change or a lane change as a turn signal lever is manipulated, wherein a moving means of the side mirror is operated to convert a thin film minor into the convex mirror for providing a wide view in association with the manipulation of the turn signal lever, so that a driver may stably observe a road behind and prevent traffic accidents.

Further, as a gear shift is manipulated for backing a vehicle, the side minors mounted at the right and left sides of the vehicle are simultaneously converted to the convex mirrors according to a gear manipulation signal so as to help a driver to recognize a road condition behind in a wide range, thereby promoting convenience.

Therefore, according to the present invention, the side mirror control apparatus removes the generation of a blind spot, resolves the inconvenience caused by that a driver looks around as fast as possible for checking the blind spot with the naked eyes, and helps a driver to change lanes by simply and safely checking the side mirrors.

From the foregoing disclosure and the following more detailed description of various preferred embodiments it will be apparent to those skilled in the art that the present invention provides a significant advance in the technology of side mirror control apparatus. Additional features and advantages of various preferred embodiments will be better understood in view of the detailed description provided below.

### BRIEF DESCRIPTION OF THE DRAWINGS

The objects, features and advantages of the present invention will be more clearly understood from the preferred embodiments in the following detailed description in conjunction with the accompanying drawings, in which:

FIG. 1 is a top plan view showing a reflection angle of planar sides mirror mounted to a vehicle with another vehicle in a blind spot of the side mirrors;

FIG. 2 is a cross-sectional view showing internal structure of a side mirror according to the present invention;

FIG. 3 is a schematic view showing an operational configuration of a side mirror control apparatus according to the present invention;

FIG. 4 is a schematic view showing an operational state of the side mirror control apparatus according to the present invention; and

FIG. 5 is a schematic view showing an operational state of the side mirror control apparatus at reverse shifting according to the present invention.

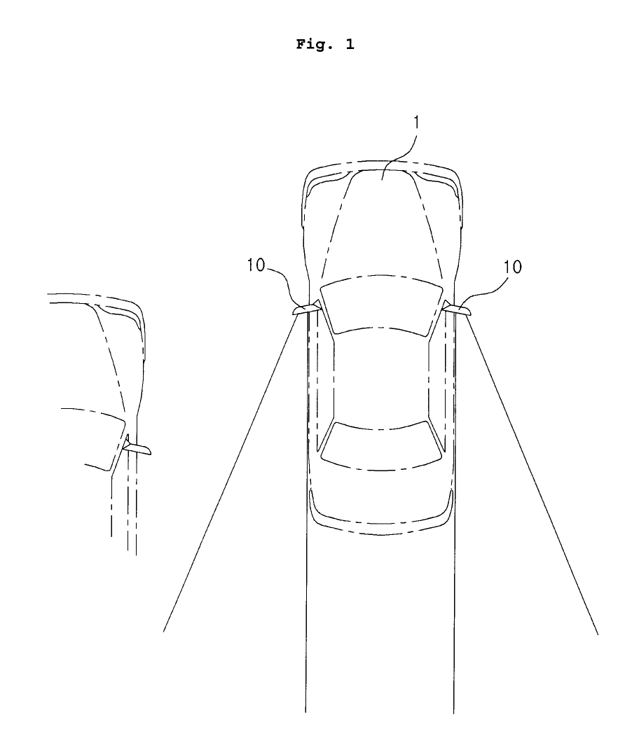

It should be understood that the appended drawings are not necessarily to scale, presenting a somewhat simplified representation of various preferred features illustrative of the basic principles of the invention. The specific design features of the side mirror control apparatus as disclosed herein, including, for example, specific dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the device illustrated in the drawings.

### DETAILED DESCRIPTION OF CERTAIN PREFERRED EMBODIMENTS

Hereinafter, an embodiment of a side mirror control apparatus which embodies the invention will be described by reference to the drawings.

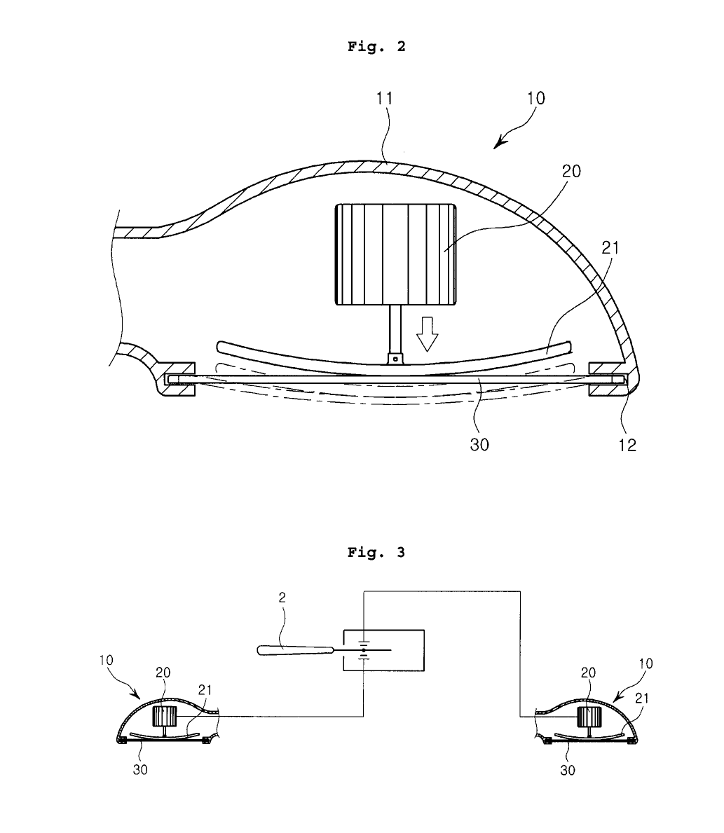

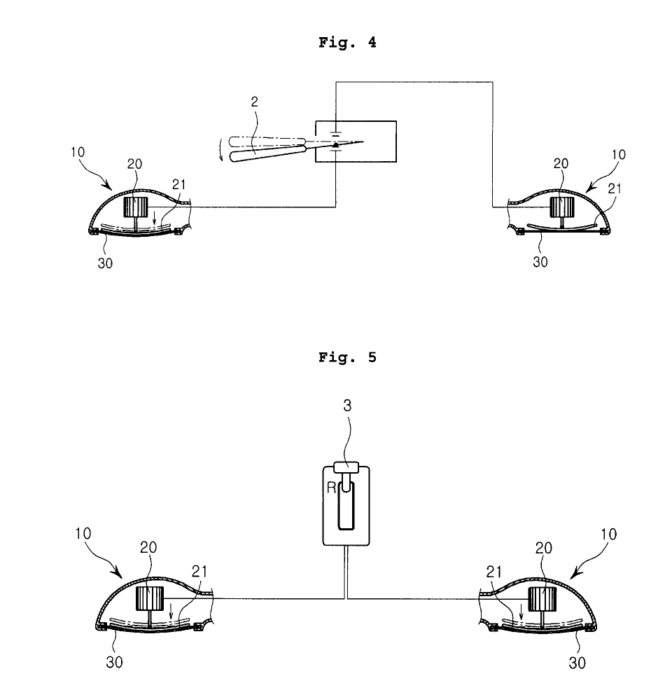

In the drawings, FIG. 2 is a cross-sectional view showing the internal structure of a side mirror according to the present invention, FIG. 3 is a schematic view showing an operational configuration of a side mirror control apparatus according to the present invention, FIG. 4 is a schematic view showing an operational state of the side mirror control apparatus according to the present invention, and FIG. 5 is a schematic view showing an operational state of the side mirror control apparatus at reverse shifting according to the present invention.

According to a side mirror control apparatus of the present invention, as a turn signal lever 2 is manipulated for changing directions or lanes during the road-traveling of a vehicle 1, a film mirror 30 of a side mirror 10 in a corresponding direction converted to be curved simultaneously with the blinking of a corresponding turn signal lamp, so that a road condition behind may be easily recognized and a traffic accident due to a blind spot may be prevented in advance.

Side mirrors 10 are mounted at the right and left sides of a vehicle 1 as shown in FIG. 2, and each includes a housing 11 mounted with a moving means 20 and a thin film mirror 30 coupled with the moving means 20 inside the housing 11. The housing 11 is formed with a holding groove 12 in a rim portion of a front surface thereof and the film mirror 30 formed of a flexible material is fitted into the groove 12, wherein the film mirror 30 may slide along the holding groove 12 and a moving means 20 is positioned in the center portion of a rear surface of the film mirror 30 for piston movement.

As for the moving means 20 described above, any one of an electric motor, a solenoid, or an actuator, which carries out the piston movement according to an electric signal, may be employed according to an installation environment thereof.

As the turn signal lever 2 is manipulated in a certain direction by a driver, an electric signal of the manipulation is simultaneously transmitted to a corresponding turn signal lamp and the moving means 20 of a corresponding one of the side mirrors 10, so that a driving part of the moving means 20 moves forwards.

In the meantime, as the turn signal lever 2 is returned in position after a driver changes directions or lanes, the electric signal for the turn signal lamp and the moving means 20 is blocked so that the moving means 20 is also returned in position.

In addition, the moving means 20 is fixed with a pressing plate 21 at an end of the driving part and in contact with a rear surface of the film mirror 30, so that the pressing plate 21 makes the center portion of the film mirror 30 protruded curvedly to be turned into a convex mirror when the driving part moves forwards. On the other hand, if the driving part moves backwards, the film mirror 30 is turned into a plane or planar mirror by the resilient elasticity thereof.

The pressing plate 21 is entirely in the spherical shape, wherein the pressing plate 21 pushes the film mirror 30 as the driving part moves forwards in such a manner that the film mirror 30 is converted into the spherical shape corresponding to that of the pressing plate.

At this time, the holding groove 12 of the housing 11 may receive the deformation of the film mirror 30 and the rim portion of the film mirror 30 which is inserted into the holding groove 12 may slide in the holding groove 12 with a sufficient clearance.

The film mirror 30 described above is a mirror having a reflection surface formed on a thin flexible metal plate or a flexible plastic plate, wherein the center portion of the film mirror 20 is pressed while the rim portion of the film mirror 20 is supported in the holding groove 12, so that the center portion of the film mirror 30 is protruded in the spherical shape and the planar film mirror 30 is converted into a convex mirror having a wide reflection angle. As the pressing force is removed, the film mirror 30 is returned from the convex mirror state to the initial plane mirror state.

As described hereinabove, according to the present invention, as the turn signal lever is manipulated for changing lanes or directions, the right or left turn signal lamp blinks according to the manipulation direction of the turn signal lever, and simultaneously the right or left moving means 20 is transmitted with the direction signal of the turn signal lever so that the film mirror 30 is protruded in the spherical shape.

Therefore, in response to the manipulation of the turn signal lever 2, the turn signal lamp in the vehicle change direction operates and the film mirror 30 of the corresponding side mirror 10 is curvedly converted for providing a clear rear view, so that various rear-end collisions, negligent accidents or the like caused by a blind spot may be prevented in advance.

Further, if a gear shift 3 of the vehicle 1 is manipulated for backing the vehicle 1 as shown in FIG. 5, the film mirrors 30 of the side mirrors 10 mounted at the right and left sides of the vehicle 1 are simultaneously converted into the convex mirrors by a corresponding signal, thereby promoting the wide recognition of a road condition behind.

In other words, in the case that the vehicle 1 is backing or driving in reverse by the manipulation of the gear shift 3, the corresponding electric signal is simultaneously transmitted to a backup light and the moving means 20 of the side mirrors 10 at the both right and left sides so that the driving parts of all the moving means 20 make the film mirrors 30 curved.

In the meantime, if the gear shift 3 is manipulated for advancing the vehicle 1 in a forward direction, the transmission of the electric signal is blocked for the both backup light and the moving means 20 so that the film mirrors 30 are returned in position.

The side mirror control apparatus according to the present invention may be advantageously installed in the side mirrors 10 of various vehicles regardless of the types of the vehicles without limitation in the use thereof.

While the invention has been described in detail with reference to the embodiment, it should be understood by those skilled in the art that various alternations and modifications can be made without departing from the spirit and scope of the invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A device for adjusting side mirrors of an automobile mounted on right and left sides of a vehicle body, the automobile having a turn signal lever, said device comprising moving means mounted in a housing to be controlled by manipulation of the turn signal lever and a film mirror fitted in a holding groove of the housing in front of the moving means.

2. A device for adjusting side mirrors according to claim 1, wherein the moving means is driven according to a signal in response to the manipulation of the turn signal lever so that a pressing plate integrally assembled in front of the moving means is in contact with a rear surface of the film mirror and so that the film mirror becomes convex while the pressing plate moves forwards.

3. A device for adjusting side mirrors according to claim 1, wherein the moving means is configured by employing one of an electric motor, a solenoid, and an actuator.

4. A device for adjusting side mirrors according to claim 1, wherein the moving means is driven at both right and left sides of the vehicle simultaneously for making the film mirror convex if a gear shift of the vehicle is manipulated to a reverse shift stage.
